(19) United States
(12) Patent Application Publication
(10) Pub. No.: US 2026/0164391 A1
(43) Pub. Date: Jun. 11, 2026

(54) SUBSCRIBER IDENTITY MODULE LOCATION SERVICE USING DEVICE GEOLOCATION DATA

(71) Applicant: T-MOBILE INNOVATIONS LLC, Overland Park, KS (US)

(72) Inventors: Kulandaivel MARAPPA GOUNDER, Bothell, WA (US); Kyeong Hun AN, Sammamish, WA (US); Nilesh RANJAN, Sammamish, WA (US)

(21) Appl. No.: 18/973,954

(22) Filed: Dec. 9, 2024

(51) Int. Cl. H04W 64/00; H04W 8/18; H04W 24/02

(52) U.S. Cl. CPC H04W 64/00; H04W 8/183; H04W 24/02

(57) ABSTRACT

Embodiments of the present disclosure are directed to systems and methods for determining the location of a user device using a subscriber identity module (SIM). The system includes an application installed on the SIM, which detects when the user device has moved locations based on geolocation data such as GPS data. Upon detecting movement, the application requests geolocation data from the user device, processes the data to determine both historical and current locations, and stores the historical location data for future use. The system further allows the SIM to respond to location requests from an external network, securely transmitting both the historical and current location data. Machine learning techniques can be employed to optimize geolocation data requests, enhance accuracy, and improve efficiency based on historical movement patterns.

### SUMMARY

The present disclosure is directed, in part, to methods and systems for enhancing location-based services in mobile communication devices through the use of a subscriber identity module (SIM) applet, substantially as shown and/or described in connection with the figures. This disclosure provides innovative mechanisms for utilizing a SIM applet to request and process location data, thereby enabling advanced location-based functionalities.

According to various aspects of the technology, the disclosed methods introduce solutions to the problem of obtaining accurate and secure location information in mobile communication networks. By implementing a SIM applet capable of interacting with the user device and external servers, the disclosed methods and systems ensure that precise location data can be collected, processed, and utilized for various applications. These outcomes are achieved through a method where the SIM applet requests geolocation data, including GPS coordinates, directly from the user device. The SIM applet requests this geolocation data, processes it, and securely transmits it to external servers, enabling accurate geolocation services for real-time and historical analysis.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure can be employed;

FIG. 3 illustrates an exemplary network environment in which implementations of the present disclosure can be employed;

FIG. 4A and FIG. 4B illustrate an exemplary network environment in which implementations of the present disclosure can be employed; and

FIG. 5 illustrates a flow diagram of an exemplary method for determining the location of a user device using a SIM.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein can be embodied as, among other things, a method, system, or computer-program product. Accordingly, the embodiments can take the form of a hardware embodiment, or an embodiment combining software and hardware. An embodiment takes the form of a computer-program product that includes computer-useable instructions embodied on one or more computer-readable media that can cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Modern mobile communication networks rely heavily on precise and secure location-based services to provide users with accurate positioning, navigation, and various location-dependent applications. A critical component in enabling these services is the subscriber identity module (SIM), which can be enhanced to collect and transmit geolocation data securely and efficiently. Users of mobile networks often require accurate geolocation data for purposes such as navigation, tracking, emergency services, and business analytics.

Conventionally, obtaining accurate and secure geolocation data has been challenging due to reliance on external applications or additional hardware. These methods often lack the integration and security features provided by SIM-based solutions. Existing solutions do not leverage the potential of the SIM card to serve as a central hub for collecting and transmitting geolocation data. As a result, there is a gap in the ability to provide seamless, secure, and integrated geolocation services directly from the SIM, leading to inefficiencies and potential security risks.

In contrast to conventional solutions, the present disclosure provides an innovative method that leverages the capabilities of a SIM applet to enhance geolocation services. The disclosed method includes a SIM applet that requests geolocation data, including GPS coordinates, directly from the user device. This geolocation data is processed and securely transmitted to external servers, enabling accurate real-time and historical geolocation services. By utilizing the SIM applet for this purpose, the invention ensures that geolocation data is collected and transmitted securely, enhancing overall network integrity and providing valuable insights for various applications.

Accordingly, a first aspect of the present disclosure provides a system for determining and storing historical location data of a user device. This system comprises one or more computer processing components configured to perform specific operations designed to accurately locate the user device using geolocation data and maintain a historical record of its locations. The operations begin with determining, by an application installed on a SIM within the user device, that the user device has moved locations. Upon detecting this movement, the SIM application requests, from the user device, geolocation data associated with the user device, including GPS coordinates, timestamps, and other relevant location information. The system then determines a historical location of the user device using the geolocation data. The system processes the geolocation data to compute the location of the user device and stores the determined location to create a historical location record. Machine learning techniques can be used to optimize the frequency of data requests based on historical movement patterns. Finally, the system communicates the historical location record and the current location of the user device to an external server, ensuring that the location information is securely transmitted to the network or service provider requesting it.

In a second aspect of the present disclosure, a method for determining and storing historical location data of a user device is provided. This method comprises a sequence of steps that the SIM performs to accurately locate the user device using geolocation data and maintain a historical record of its locations. The method begins with determining, by an application installed on a SIM within the user device, that the user device has moved locations. The SIM application detects this movement by analyzing geolocation data, such as GPS data, and prepares to collect additional location data from the user device. The next step involves requesting, from the user device by the application, geolocation data associated with the user device, including GPS coordinates, timestamps, and other location data. Upon receiving the geolocation data, the method proceeds to determine a historical location of the user device by processing the received GPS data. The determined location data is then stored to create a historical location record. The method can further use machine learning techniques to optimize the intervals for collecting geolocation data. Finally, the method involves securely communicating the historical location record and the current location of the user device to an external server.

Another aspect of the present disclosure is directed to a non-transitory computer-readable medium having instructions stored thereon that, when executed by one or more computer processing components, cause the one or more computer processing components to perform a method for determining and storing historical location data of a user device. The method comprises several key steps designed to accurately locate the user device using geolocation data and maintain a historical record of its locations. The method begins with determining, by an application installed on a SIM within the user device, that the user device has moved locations. Upon detecting this movement, the SIM application prepares to process the request by engaging with the user device's internal components and network interfaces. The next step involves requesting, from the user device by the application, geolocation data associated with the user device, including GPS coordinates and timestamps. The method then proceeds to determine a historical location of the user device by processing the received geolocation data. The system can apply machine learning algorithms to predict future movement patterns based on historical data. The determined location data is then stored to create a historical location record. Finally, the method involves securely transmitting the historical location record and the current location of the user device to an external server, ensuring the confidentiality and integrity of the transmitted location data.

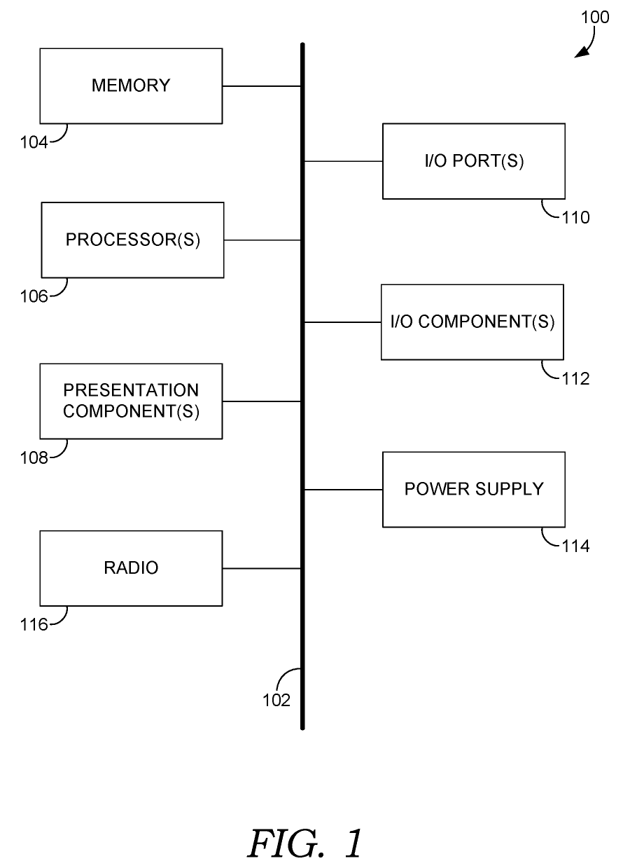

Referring to the drawings in general, and initially to FIG. 1, an exemplary computing environment 100 suitable for practicing embodiments of the present technology is provided. Computing environment 100 is just one example, and is not intended to suggest any limitation as to the scope of use or functionality of the embodiments discussed herein. Furthermore, the computing environment 100 should not be interpreted as having any dependency or requirement relating to any one or a combination of components illustrated. It should be noted that although some components in FIG. 1 are shown in the singular, they might be plural. For example, the computing environment 100 might include multiple processors and/or multiple radios. As shown in FIG. 1, computing environment 100 includes a bus 102 that directly or indirectly couples various components together, including memory 104, processor(s) 106, presentation component(s) 108 (if applicable), radio(s) 116, input/output (I/O) port(s) 110, input/output (I/O) component(s) 112, and power supply 114. More or fewer components are possible and contemplated, including in consolidated or distributed form.

Memory 104 can take the form of memory components described herein. Thus, further elaboration will not be provided here, but it should be noted that memory 104 can include any type of tangible medium that is capable of storing information, such as a database. A database can be any collection of records, data, and/or information. In one embodiment, memory 104 can include a set of embodied computer-executable instructions that, when executed, facilitate various functions or elements disclosed herein. These embodied instructions will variously be referred to as “instructions” or an “application” for short. Processor 106 can actually be multiple processors that receive instructions and process them accordingly. Presentation component 108 can include a display, a speaker, and/or other components that can present information (e.g., a display, a screen, a lamp (LED), a graphical user interface (GUI), and/or even lighted keyboards) through visual, auditory, and/or other tactile cues.

Radio 116 can facilitate communication with a network, and can additionally or alternatively facilitate other types of wireless communications, such as Wi-Fi, WiMAX, LTE, and/or other VoIP communications. In various embodiments, the radio 116 can be configured to support multiple technologies, and/or multiple radios can be configured and utilized to support multiple technologies. The input/output (I/O) ports 110 can take a variety of forms. Exemplary I/O ports can include a USB jack, a stereo jack, an infrared port, a firewire port, other proprietary communications ports, and the like. Input/output (I/O) components 112 can comprise keyboards, microphones, speakers, touchscreens, and/or any other item usable to directly or indirectly input data into the computing environment 100. Power supply 114 can include batteries, fuel cells, and/or any other component that can act as a power source to supply power to the computing environment 100 or to other network components, including through one or more electrical connections or couplings. Power supply11 4 can be configured to selectively supply power to different components independently and/or concurrently.

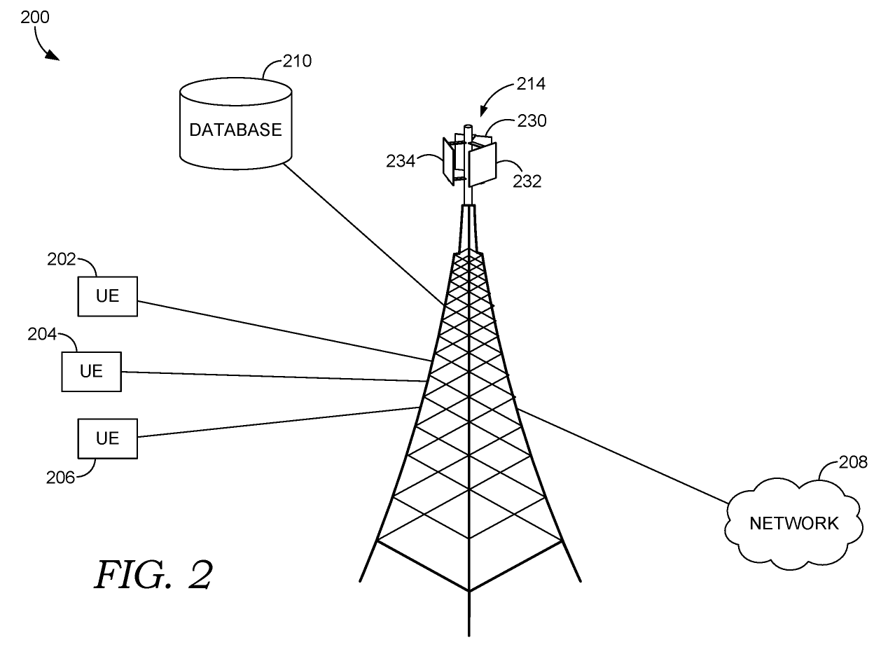

FIG. 2 provides an exemplary network environment in which implementations of the present disclosure can be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 includes one or more user devices (e.g., user devices 202, 204, and 206), cell site 214, network 208, and database 210. In network environment 200, user devices can take on a variety of forms, such as a personal computer (PC), a user device, a smart phone, a smart watch, a laptop computer, a mobile phone, a mobile device, a tablet computer, a wearable computer, a personal digital assistant (PDA), a server, a global positioning system (GPS) device, a video player, a handheld communications device, a workstation, a router, an access point, and any combination of these delineated devices, or any other device that communicates via wireless communications with a cell site 214 in order to interact with a public or private network.

In some aspects, the user devices 202, 204, and 206 correspond to computing device 100 in FIG. 1. Thus, a user device can include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, 6G, CDMA, or any other type of network.

In In other aspects, the user devices 202, 204, and 206 encompass a diverse range of high-throughput and high data consumption devices, catering to various user needs and environments. The first device, 202, corresponds to a Home Internet Network Terminal (HINT). Device 204 represents a Fixed Wireless Access (FWA) device, which provides internet access in areas where wired connectivity is limited or unavailable.

Additionally, user devices 202, 204, and 206 can be any device characterized by high data throughput needs, such as advanced gaming consoles that require rapid data exchange for real-time multiplayer experiences, or professional-grade video conferencing systems used in businesses for high-quality virtual meetings. This category also includes emerging Internet of Things (IoT) devices, like intelligent security cameras and smart home appliances, which constantly transmit and receive data for automation and monitoring purposes. Furthermore, high-performance tablets and laptops also fall under this category, as they require high-speed internet for cloud computing and large file transfers.

In some cases, the user devices 202, 204, and 206 in network environment 200 can optionally utilize network 208 to communicate with other computing devices (e.g., a mobile device(s), a server(s), a personal computer(s), etc.) through cell site 214. The network 208 can be a telecommunications network(s), or a portion thereof. A telecommunications network might include an array of devices or components (e.g., one or more base stations), some of which are not shown. Those devices or components can form network environments similar to what is shown in FIG. 2, and can also perform methods in accordance with the present disclosure. Components such as terminals, links, and nodes (as well as other components) can provide connectivity in various implementations. Network 208 can include multiple networks, as well as being a network of networks, but is shown in more simple form so as to not obscure other aspects of the present disclosure.

Network 208 can be part of a telecommunication network that connects subscribers to their service provider. In aspects, the service provider can be a telecommunications service provider, an internet service provider, or any other similar service provider that provides at least one of voice telecommunications and data services to any or all of the user devices 202, 204, and 206. For example, network 208 can be associated with a telecommunications provider that provides services (e.g., LTE, 4G, 5G, 6G) to the user devices 202, 204, and 206. Additionally or alternatively, network 208 can provide voice, SMS, and/or data services to user devices or corresponding users that are registered or subscribed to utilize the services provided by a telecommunications provider. Network 208 can comprise any communication network providing voice, SMS, and/or data service(s), using any one or more communication protocols, such as a 1x circuit voice, a 3G network (e.g., CDMA, CDMA2000, WCDMA, GSM, UMTS), a 4G network (WiMAX, LTE, HSDPA), a 5G network, or a 6G network. The network 208 can also be, in whole or in part, or have characteristics of, a self-optimizing network.

In some implementations, cell site 214 is configured to communicate with the user devices 202, 204, and 206 that are located within the geographical area defined by a transmission range and/or receiving range of the radio antennas of cell site 214. The geographical area can be referred to as the “coverage area” of the cell site or simply the “cell,” as used interchangeably hereinafter. Cell site 214 can include one or more base stations, base transmitter stations, radios, antennas, antenna arrays, power amplifiers, transmitters/receivers, digital signal processors, control electronics, GPS equipment, and the like. In particular, cell site 214 can be configured to wirelessly communicate with devices within a defined and limited coverage area. In an exemplary aspect, the cell site 214 comprises a base station that serves at least one sector of the cell associated with the cell site 214, and at least one transmit antenna for propagating a signal from the base station to one or more of the user devices 202, 204, and 206. In other aspects, the cell site 214 can comprise multiple base stations and/or multiple transmit antennas for each of the one or more base stations, any one or more of which can serve at least a portion of the cell. For example, the cell site can comprise a first antenna array 230, a second antenna array 232, and a third antenna array 234, wherein each of the antenna arrays serves a distinct sector (i.e., portion) of the coverage area of the cell 214. In some aspects, the cell site 214 can comprise one or more macro cells (providing wireless coverage for users within a large geographic area) or it can be a small cell (providing wireless coverage for users within a small geographic area).

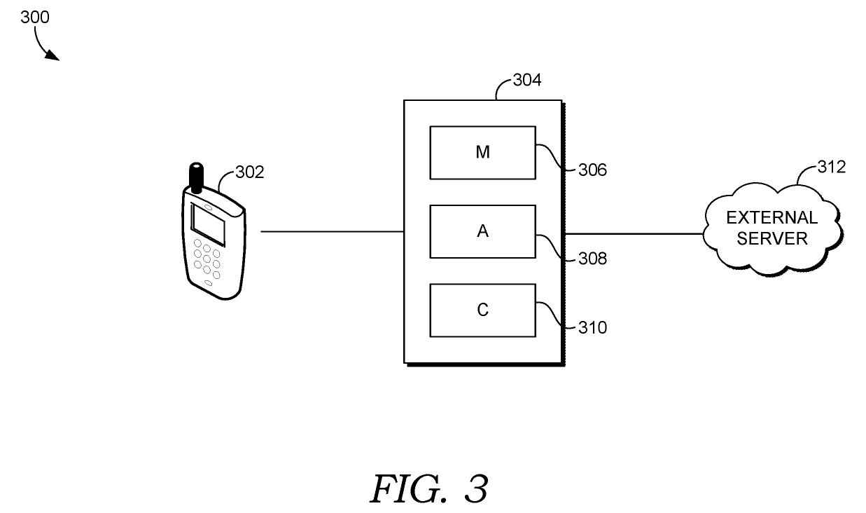

FIG. 3 provides an exemplary network environment in which implementations of the present disclosure can be employed. Such a network environment is illustrated and designated generally as network environment 300. Network environment 300 is but one example of a suitable network environment and is not intended to suggest any limitation as to the scope of use or functionality of the invention. Neither should the network environment be interpreted as having any dependency or requirement relating to any one or combination of components illustrated. The network environment 300 includes a user equipment (UE) 302 that is capable of operating in network environment 300. The network environment 300 additionally comprises one or more hardware and/or software components that, together, make up a SIM applet 304 installed on the SIM within the UE 302. The SIM applet 304 comprises a monitor 306, an analyzer 308, a controller 310, and an external server 312.

The monitor 306 is responsible for determining that the UE 302 has moved locations by monitoring GPS location data. Specifically, the monitor 306 detects a movement of the UE 302 by comparing GPS location coordinates over time. This movement detection can be based on the determination that the UE 302 has moved more than a pre-determined distance according to the GPS data, which triggers the capturing of location information for historical purposes. Upon detecting such a movement, the monitor 306 retrieves GPS location data associated with the user device.

Additionally, the monitor 306 periodically requests GPS location data at predefined time intervals to update the location of the UE 302. These predefined intervals can be dynamically adjusted based on the movement and/or speed of the UE 302, ensuring accurate and timely updates of the location information. Machine learning algorithms can be used to optimize the interval selection, adjusting the frequency of GPS requests based on past movement patterns and behaviors of the user device. This allows the system to conserve battery power and reduce network usage while maintaining precise location tracking. This periodic request mechanism allows the SIM applet to continuously monitor the location of the UE 302 and provide real-time updates. The intervals can be configured based on various factors, including the speed of movement and the specific requirements of the network or service provider.

Once the GPS data is retrieved, the analyzer 308 processes the received GPS coordinates to determine the location of the UE 302. This process involves using algorithms to calculate the current location and compare it with previous locations to track movement. The analyzer 308 can further refine the accuracy of the GPS data by using additional sensor data or correcting for known inaccuracies in GPS signals in certain environments (e.g., urban areas with signal obstructions). In addition, machine learning techniques can be used to analyze and predict movement patterns, allowing the system to anticipate user movements based on historical data. This predictive capability can enhance the system's responsiveness and accuracy, particularly in situations where real-time GPS signals are less reliable, such as indoors or in dense urban areas.

In addition to machine learning algorithms used to optimize data collection intervals and predict movement patterns, the system employs pattern recognition algorithms to analyze geolocation data for detecting inconsistencies or anomalies in movement. These algorithms compare real-time geolocation data, such as GPS coordinates, with historical movement patterns stored in the system. For example, sudden changes in location that do not align with typical user behavior or signal fluctuations can trigger the system to flag potential anomalies. The pattern recognition algorithms can also identify unusual travel speeds, unexpected deviations from routine paths, or data inconsistencies caused by signal interference or spoofing. By integrating these algorithms with machine learning techniques, the system continuously refines its ability to detect irregularities, enhancing both the accuracy and reliability of location tracking.

In addition to GPS data, the SIM applet can collect geolocation data from multiple sensors associated with the user device. These sensors can include Wi-Fi signals, cellular network data, and Bluetooth signals, each contributing to the determination of the device's location. The use of multiple sensors allows for enhanced accuracy, particularly in environments where GPS signals are weak or unavailable, such as indoor locations or dense urban areas. The SIM applet can intelligently combine data from these various sources to generate a more precise geolocation result.

The analyzer 308 can also employ machine learning algorithms to refine the accuracy of the location determination over time based on historical location data. The validation process involves comparing the received GPS data with previously recorded movement patterns. The use of machine learning techniques allows the system to learn from historical data and improve the precision of the location determination algorithm. For instance, supervised learning models trained on historical GPS data can be incorporated to identify patterns in user movement, which can enhance the system’s ability to adjust GPS sampling rates, predict future locations, and optimize power consumption. In certain embodiments, reinforcement learning can also be used to dynamically adjust the system’s behavior based on user-specific movement tendencies, improving efficiency and location accuracy over time.

The controller 310 manages the overall operation of the SIM applet 304, including the secure communication of the determined current location and historical location and record to the external server 312. The controller 310 uses a secure communication protocol such as TLS/SSL to transmit the location data to the external server 312, ensuring the privacy and security of the location information. This step ensures that the location information is securely delivered to the network or service provider requesting it, maintaining the confidentiality and integrity of the transmitted data. The SIM applet ensures that all geolocation data, including both the current location and historical location records, is transmitted securely to the external server 312. This secure communication is achieved using standard encryption protocols such as TLS/SSL, preventing unauthorized access to the data. The integrity and confidentiality of the location information are maintained throughout the communication process, ensuring that only authorized entities can access the transmitted data.

The controller 310 manages the storage of historical location data within the SIM. This involves storing the determined GPS location data at predefined intervals to create a historical location record. The historical data is securely maintained within the SIM and can be retrieved when needed. The controller 310 ensures that the historical location data is periodically updated based on the movement of the UE 302 and changes in its GPS location. Machine learning techniques can be applied to this historical data, allowing the system to improve its location prediction accuracy by identifying recurring patterns of movement.

In one embodiment, the machine learning models operate by predicting the location of the UE 302 based on real-time geolocation or GPS data, leveraging historical data collected from prior measurements. This process involves training a supervised learning model, such as a gradient-boosted decision tree or support vector machine, which can correlate specific GPS coordinates with known geographic locations and current or futures events. Over time, the model continuously updates its predictions, learning from new data as it is collected. Additionally, the machine learning model can filter out signal noise and anomalies that can arise due to environmental factors, such as interference from nearby devices or adverse weather conditions. In such cases, a Kalman filter or similar noise reduction technique can be applied to improve the accuracy of the signal analysis.

Moreover, the machine learning techniques enable dynamic optimization of sampling intervals based on movement patterns of the UE 302. For instance, the analyzer 308 can adjust the frequency of location updates when the device is moving rapidly or predictively reduce the sampling rate when the device is stationary or in a known location, thereby conserving processing resources and battery life. In some implementations, deep learning algorithms, such as convolutional neural networks (CNNs), can be employed to further enhance the system’s ability to detect subtle patterns in the signal data that correspond to specific geolocations, particularly in environments where signal reflections or attenuation are prevalent.

In further embodiments, the analyzer 308 employs machine learning techniques to continuously improve the accuracy and reliability of location determination. The ML models can include supervised learning algorithms trained on historical datasets comprising previously captured geolocations. These models enable the system to recognize and predict the likely location of the UE 302 based on current signal data and other data associated with the location or user. The supervised learning models can include algorithms such as decision trees, neural networks, or support vector machines, each of which is capable of mapping complex relationships between signal strength, signal noise, and geolocation.

In addition to supervised learning, unsupervised learning techniques can be used to detect anomalies in the received signal data. For example, if the signal measurements deviate from expected patterns derived from historical data, an unsupervised learning model, such as k-means clustering or an isolation forest, can flag the data as potentially erroneous or indicative of interference, spoofing, or equipment malfunction. Such anomaly detection serves to validate the accuracy of the location determination and helps to ensure that the location data provided by the analyzer 308 is reliable and free from inaccuracies caused by abnormal network conditions.

The SIM applet can also utilize pattern recognition algorithms to detect anomalies or discrepancies in the movement data of the user device. These algorithms can analyze geolocation data patterns based on historical records and real-time data, identifying potential inconsistencies such as sudden, unexpected changes in location or movements that do not align with typical user behavior. By employing machine learning techniques such as anomaly detection, the system can flag irregularities that might indicate errors in location tracking or external interference.

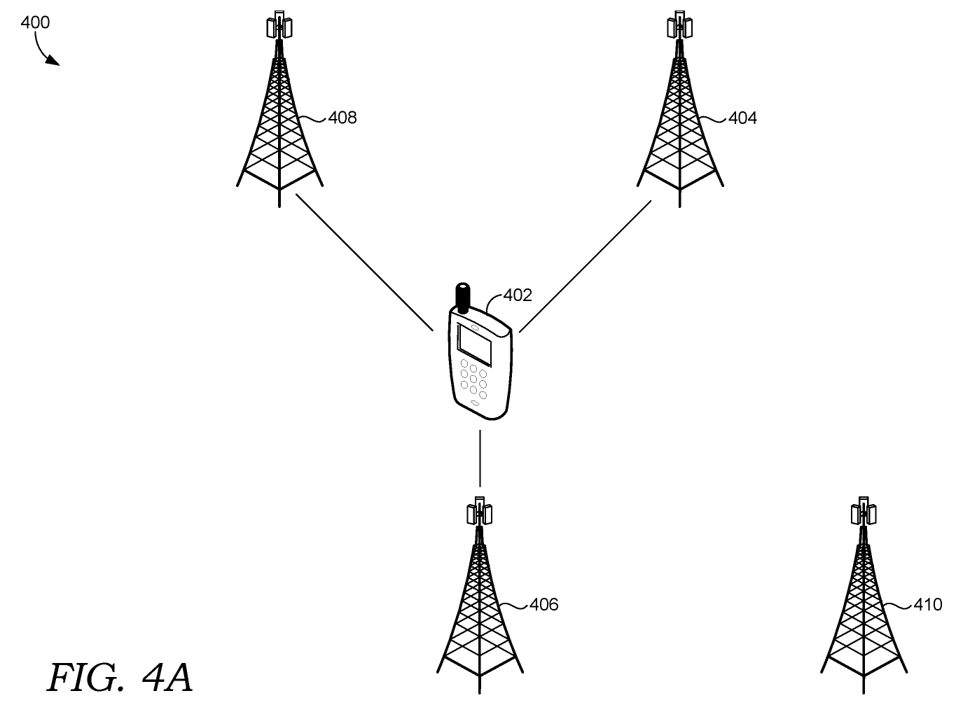

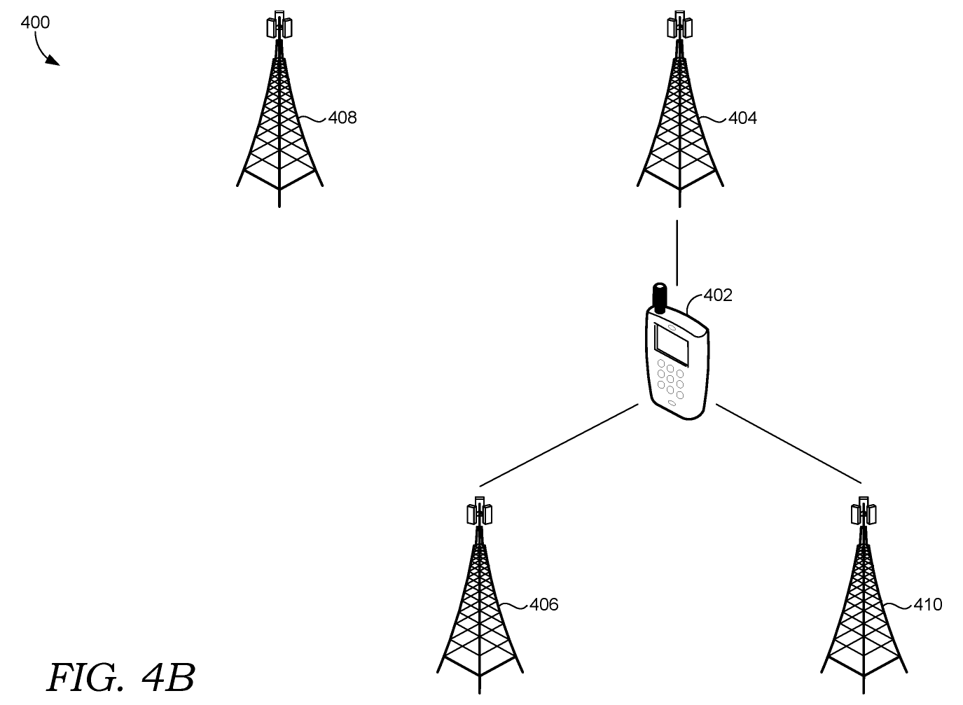

FIGS. 4A and 4B provide exemplary network environments in which implementations of the present disclosure can be employed. These network environments are illustrated and designated generally as network environment 400. Network environment 400 is but one example of a suitable network environment and is not intended to suggest any limitation as to the scope of use or functionality of the invention. Neither should the network environment be interpreted as having any dependency or requirement relating to any one or combination of components illustrated. Network environment 400 includes a UE 402, a first cell site 404, a second cell site 406, a third cell site 408, and a fourth cell site 410. The UE 402 is capable of operating within the network environment 400 and communicating with multiple cell sites. Each cell site (404, 406, 408, and 410) represents a network node providing wireless communication coverage to the UE 402. These cell sites are part of a larger cellular network infrastructure that facilitates the transmission and reception of data.

FIG. 4A illustrates the UE 402 attached to the first cell site 404, second cell site 406, and third cell site 408. In this state, the UE 402 is maintaining optimal connectivity with these cell sites, allowing for seamless communication. FIG. 4B shows the UE 402 moving and attaching to the fourth cell site 410, resulting in detachment from the third cell site 408. The SIM applet installed on the SIM within the UE 402 detects this movement by monitoring changes in the UE’s GPS location. Specifically, the SIM applet determines that the UE 402 has moved more than a pre-determined distance and requests the current GPS location of the UE 402. This GPS location is then recorded as part of the historical location record.

FIG. 4B shows the UE 402 moved to attach to the fourth cell site 410 and not to the third cell site 408. This movement prompts the SIM applet to gather GPS data to generate a historical location data set. The SIM applet detects the UE 402's movement by determining that the UE 402 has traveled more than a pre-determined distance based on the GPS data. The movement of the UE 402 can also be detected based on changes in the GPS coordinates indicating a significant shift in location. In this process, machine learning can be incorporated to analyze previous GPS movement patterns, enabling the system to adjust the frequency of GPS data requests dynamically based on anticipated user movement behavior.

The SIM applet requests GPS location data associated with the UE 402. The SIM applet processes the received GPS data to determine the location of the UE 402. This process involves analyzing the GPS coordinates and comparing them to previous locations stored in the historical location record. The SIM applet updates the historical record with the new GPS coordinates and timestamps to maintain an accurate log of the UE 402's movements. Machine learning models can also assist in predicting the user’s future movements by comparing real-time GPS data with previously learned patterns, thus enabling the system to anticipate the user’s likely location and improve the accuracy of location-based services.

Additionally, the SIM applet periodically requests GPS data at predefined intervals to update the location of the UE 402. These predefined intervals can be dynamically adjusted based on the movement speed of the UE 402, ensuring accurate and timely updates of the GPS location information. This periodic request mechanism allows the SIM applet to continuously monitor the location of the UE 402 and provide real-time updates. Machine learning can further optimize the interval timing by learning from historical data and adjusting the request intervals to reduce unnecessary location updates, thus conserving resources without sacrificing accuracy.

The storage of historical GPS location data within the SIM involves storing the determined GPS coordinates at predefined intervals to create a historical location record. The historical data is securely maintained within the SIM and can be retrieved when needed. The historical GPS location data and historical record are periodically updated based on the movement of the UE 402 as determined by changes in the GPS coordinates. For example, each time the UE 402 changes its GPS location by more than the pre-determined distance, the SIM applet updates the historical record with the new GPS location and timestamp. Over time, machine learning algorithms can use this historical location data to enhance future location predictions by identifying trends and behaviors that indicate where the UE 402 is likely to move next.

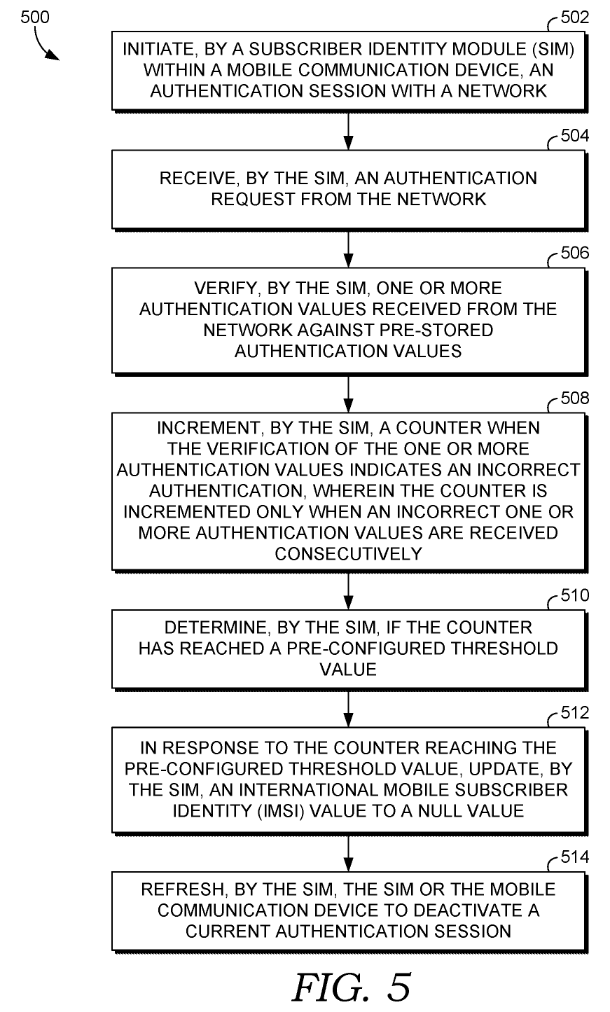

Turning now to FIG. 5, a flow chart is provided that illustrates one or more aspects of the present disclosure relating to a method 500 for determining the location of a user device. The method 500 begins at block 502 with determining, by an application installed on a subscriber identity module (SIM) within the user device, that the user device has moved locations. This initial step involves the SIM application detecting that the user device has moved based on the analysis of GPS location data. The application continuously monitors the device's movement using GPS data and triggers this detection once the user device moves more than a pre-determined distance. Upon detecting the movement, the SIM application prepares to process the data by engaging with the user device's internal components and network interfaces to capture and process the location information.

At block 504, the SIM application requests, from the user device, a first set of geolocation data associated with the user device. This geolocation data request is processed by sending a command to the user device to collect and return GPS coordinates and associated data. The geolocation data includes GPS location coordinates and additional information such as timestamps, which help identify the exact location and time of the device's movement. The first set of geolocation data enables the SIM application to begin tracking the user's movement history.

Upon receiving the geolocation data from the user device, the method proceeds to block 506, where the SIM application determines a historical location of the user device using the first set of geolocation data associated with the user device. This determination involves processing the received GPS coordinates to compute the historical location. The SIM application can use machine learning algorithms to enhance the accuracy of this historical location data by analyzing patterns and correcting for known inaccuracies in GPS signals, particularly in complex environments such as urban areas or indoor locations.

The system also includes functionality for generating alerts or notifications on the user device when a location request is processed. Upon receiving a location request from an external server or network, the SIM applet can trigger an alert on the user device to inform the user of the request. This alert can include details such as the time the request was processed, the identity of the requesting entity, and whether the requested data includes historical or real-time location information. The alert can be displayed as a pop-up notification or integrated within the device's notification center, providing transparency to the user regarding the access and transmission of their location data. The system can also allow the user to configure these alerts, enabling them to receive notifications only for certain types of requests or based on specific conditions.

At block 508, the SIM application stores the determined historical location to create a historical location record. This historical location data is stored securely within the SIM at predefined intervals, ensuring that the movement of the user device is continuously logged. The storage of this data is critical for applications that can need to reference past locations of the user device, such as for compliance, analytics, or location-based services.

The method continues at block 510, with the SIM application receiving a request from a network for the current location of the user device. This request originates from an external network server or application requiring real-time location data, such as location-based services or network optimization functions. Upon receiving this request, the SIM application prepares to gather and process the required location data by interacting with the user device.

At block 512, the SIM application requests, from the user device, a second set of geolocation data associated with the user device. This second set of data represents the current GPS location of the user device. The application sends a command to the user device, which in turn gathers the real-time GPS data and returns it to the SIM application. The real-time data includes updated GPS coordinates and any additional relevant location data needed to pinpoint the device's location accurately.

The method then proceeds to block 514, where the SIM application determines the current location of the user device based on the second set of geolocation data. The SIM application processes this real-time GPS data to calculate the precise current location of the user device. Similar to the determination of the historical location, machine learning techniques can be employed to improve the accuracy and responsiveness of the system by analyzing the current movement patterns and any known environmental factors that can affect GPS signal strength.

At block 516, the method involves providing the historical location record and the current location of the user device to an external server. The SIM application securely packages both the historical location record and the real-time location data and transmits them to the external server via a secure communication protocol such as TLS/SSL. This ensures that the location information is delivered safely to the requesting entity, preserving the privacy and integrity of the data. The external server can then utilize the location data for various purposes, including providing location-based services, optimizing network performance, or supporting emergency services. The secure and accurate transmission of this data is critical to maintaining user trust and ensuring the reliability of the overall system.

The SIM applet can also be configured to generate an alert or notification on the user device when a location request is processed. This alert can inform the user that a geolocation request has been made and that the device's current or historical location has been communicated to an external server. The notification can include additional information, such as the time of the request and the identity of the requesting entity, providing transparency and enhancing user control over their geolocation data.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and can be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that can be practiced. It is to be understood that other embodiments can be utilized and structural or logical changes can be made without departing from the scope of the present disclosure. Therefore, the preceding detailed description is not to be taken in the limiting sense, and the scope of embodiments is defined by the appended claims and their equivalents.

What is claimed is:

1. A method for determining a location for a user device, the method comprising:
determining, by an application installed on a subscriber identity module (SIM) within the user device, that the user device has moved locations;
based on the determination that the user device has moved locations, requesting, by the application, a first set of geolocation data associated with the user device;
determining a historical location of the user device based on the first set of geolocation data;
storing the determined historical location to create a historical location record;
receiving a request from an external server for a current location of the user device;
requesting, by the application, a second set of geolocation data associated with the user device;
determining the current location of the user device based on the second set of geolocation data; and
communicating the historical location record and the current location of the user device to the external server.

2. The method of claim 1, wherein the first set of geolocation data is GPS data comprising latitude, longitude, and timestamps.

3. The method of claim 1, wherein determining that the user device has moved locations comprises detecting that the user device has moved at least a pre-determined distance.

4. The method of claim 1, wherein the application requests geolocation data from the user device at one or more time intervals, and wherein the application dynamically adjusts the one or more time intervals based on a movement speed of the user device.

5. The method of claim 4 further comprising applying a machine learning algorithm to optimize the one or more time intervals geolocation data is requested based on historical movement patterns of the user device.

6. The method of claim 1, wherein the historical location record is stored on the SIM in encrypted form to prevent unauthorized access.

7. The method of claim 1, wherein the second set of geolocation data is processed to detect discrepancies in user device movement.

8. The method of claim 1, wherein providing the historical location record and the current location to the external server comprises using a secure communication protocol.

9. The method of claim 1 further comprising generating an alert on the user device indicating that a location request has been processed and communicated to the external server.

10. A method for optimizing geolocation tracking of a user device, the method comprising:
collecting, by an application installed on a subscriber identity module (SIM) within the user device, a first set of geolocation data and historical geolocation associated with the user device;
generating a set of predicted movements of the user device based on the first set of geolocation data and the historical geolocation data;
adjusting a frequency of geolocation data collection based on the set of predicted movements of the user device;
determining a historical location of the user device based on the first set of geolocation data;
receiving a request from an external server for a current location of the user device;
collecting a second set of geolocation data in response to the request; and
providing the current location and the set of predicted movements to the external server.

11. The method of claim 10, wherein the geolocation data comprises GPS coordinates and associated timestamps.

12. The method of claim 10, wherein a machine learning algorithm is trained using supervised learning techniques based on historical movement data of the user device.

13. The method of claim 10, wherein the frequency of geolocation data collection is adjusted based on a speed of movement of the user device and a time of day.

14. The method of claim 10 further comprising identifying one or more anomalies in the first geolocation data or the second geolocation data by comparing the set of predicted movements with real-time geolocation data.

15. The method of claim 10, wherein the second set of geolocation data is collected from one or more sensors associated with the user device.

16. The method of claim 12, wherein the external server uses the current location and the set of predicted movements to provide location-based recommendations to the user device.

17. A subscriber identity module (SIM) for determining and storing historical location data of a user device, the SIM comprising:
an application installed on the SIM, the application configured to:
detect when the user device has moved locations based on GPS data;
request geolocation data from the user device at predefined time intervals;
store the geolocation data within the SIM as a historical location record;
process the geolocation data to determine a current location of the user device;
receive one or more requests from an external server for the current location and the historical location record of the user device;
provide the current location and the historical location record to the external server via a secure communication protocol.

18. The system of claim 17, wherein the SIM applet employs machine learning algorithms to adjust the predefined intervals for requesting the geolocation data based on historical user movement patterns.

19. The system of claim 17, wherein the SIM applet dynamically adjusts a frequency of the predefined time intervals based on a detected movement speed of the user device.

20. The system of claim 17 further comprising a notification system that alerts the user device when a geolocation request is processed.
